(19) United States
(12) Patent Application Publication
(10) Pub. No.: US 2017/0175993 A1
(43) Pub. Date: Jun. 22, 2017

(54) Indoor/Outdoor Light Show Device

(71) Applicant: Raymond Anthony Products, LLC, Buena, NJ (US)

(72) Inventor: Anthony A. Fornataro, Richland, NJ (US)

(73) Assignee: Raymond Anthony Products, LLC, Buena, NJ (US)

(21) Appl. No.: 15/381,539

(22) Filed: Dec. 16, 2016

Related U.S. Application Data
(60) Provisional application No. 62/269,452, filed on Dec. 18, 2015.
(60) Provisional application No. 62/363,907, filed on Jul. 19, 2016.

(51) Int. Cl. F21V 33/00; F21V 23/00; A47G 33/00; F21V 21/00

(52) U.S. Cl. CPC F21V 33/0004; F21V 21/00; F21V 23/001; A47G 33/00; F21W 2121/006

(57) ABSTRACT

A light show device. The device includes a frame having a recess, a stabilizer structured to stabilize the frame, a skirting positioned over the frame, a light projection unit positioned within the recess of the frame to project a still or moving image/scene (such as a snow storm, snow flakes, candy canes, snowmen, and/or other scenery) along a predetermined direction with respect to the frame, and a power supply for providing operating power to the light projection unit. The light show device is operable indoors or outdoors to project the still or moving image/scene to illuminate an area surrounding the light show device. In one embodiment, the light show device simulates snowfall by projecting snowflake-like images in a downwardly falling pattern along the predefined direction. In various other embodiments, the device is also provided with the ability to play sounds or music while projecting the image/scene.

### BACKGROUND OF THE DISCLOSURE

Embodiments of the present disclosure generally relate to entertainment projection devices and, in particular, to indoor/outdoor light show devices.

Entertainment projection devices, such as those that produce laser light shows, are known. Such devices typically include an array of laser light sources or other lighting elements controllable to project still or moving imagery on walls, ceilings, or other surfaces for entertainment of audiences. While the imagery produced by these devices is typically entertaining and pleasing, the devices themselves are often unaesthetic and unpleasing to the eye. There exists a need to camouflage or hide entertainment projection devices in certain situations, such as when they are intended to be used in conjunction with celebrations of certain events or holidays.

### BRIEF SUMMARY OF THE DISCLOSURE

Briefly stated, in one aspect of the present invention a light show device is provided. The device includes a frame having a recess, a decorative skirting positioned over the frame and including at least one aperture, a light projection unit positioned within the recess of the frame and being operable to project an image or scene along a predetermined direction with respect to the frame through the at least one aperture, and a power supply for providing operating power to the light projection unit.

In another aspect of the present invention, a light show device is provided. The light show device includes: a stabilizing frame having a front, a rear and a recess, the recess recessed in the rear of the frame and extending outwardly and upwardly towards the rear, the stabilizing frame in the shape of a cone and structured to engage with a top of a tree for stabilizing the light show device atop the tree; a decorative skirting positioned over the frame and having an aperture; a light projection unit positioned within the recess of the frame, the light projection unit being operable to project an image or scene rearward and upward with respect to the frame, the image or scene being projected through the aperture of the skirting; and a power supply for providing operating power to the light projection unit.

In yet another aspect of the present invention, a method of simulating snowfall inside a home is provided. The method includes energizing and placing a light show device atop a tree or on a horizontal surface or in an electrical receptacle, the light show device including a frame having a recess, a decorative skirting positioned over the frame with at least one aperture, a light projection unit positioned within the recess of the frame and being operable to project snowflake-like images in a rearward and upward direction with respect to the frame through the at least one aperture, such that the snowflake-like images are projected in a downwardly falling pattern along a predetermined direction, and a power supply for providing operating power to the light projection unit.

### BRIEF DESCRIPTION OF THE SEVERAL VIEWS OF THE DRAWINGS

The foregoing summary, as well as the following detailed description of preferred embodiments of the disclosure, will be better understood when read in conjunction with the appended drawings. For the purpose of illustrating the disclosure, there is shown in the drawings embodiments which are presently preferred. It should be understood, however, that the disclosure is not limited to the precise arrangements and instrumentalities shown. In the drawings:

FIG. 1a is a side view of a light show device in accordance with one embodiment of the present invention;

FIG. 1b is a rear view of a light show device in accordance with one embodiment of the present invention;

FIG. 1c is a side view of a light show device having a stabilizer that permits a light show device to be positioned on a table or other suitable surface, in accordance with one embodiment of the present invention;

FIG. 1d is a rear view of a light show device having a stabilizer that permits a light show device to be positioned on a table or other suitable surface, in accordance with one embodiment of the present invention;

FIG. 1e is a side view of a light show device having a stabilizer that permits a light show device to be operable as a night light, in accordance with one embodiment of the present invention;

FIG. 2 is an exemplary light projection unit in accordance with one embodiment of the present invention;

FIG. 3a is a side view of a light show device for use atop a tree in accordance with one embodiment of the present invention; and

FIG. 3b is a rear view of a light show device for use atop a tree in accordance with one embodiment of the present invention.

### DETAILED DESCRIPTION OF THE DISCLOSURE

Certain terminology may be used in the following description for convenience only and is not limiting. The words “lower”, “upper”, “top”, “bottom”, “front”, and “rear” designate directions in the drawings to which reference is made. The terminology includes the words above specifically mentioned, derivatives thereof and words of similar import.

Where a term is provided in the singular, the inventors also contemplate aspects of the disclosure described by the plural of that term. As used in this specification and in the appended claims, the singular forms “a”, “an” and “the” include plural references unless the context clearly dictates otherwise, e.g., “a light emitting element” may include a plurality of light emitting elements.

Unless defined otherwise, all technical and scientific terms used herein have the same meaning as commonly understood by one of ordinary skill in the art to which this disclosure belongs. Although any methods and materials similar or equivalent to those described herein can be used in the practice or testing of the present disclosure, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

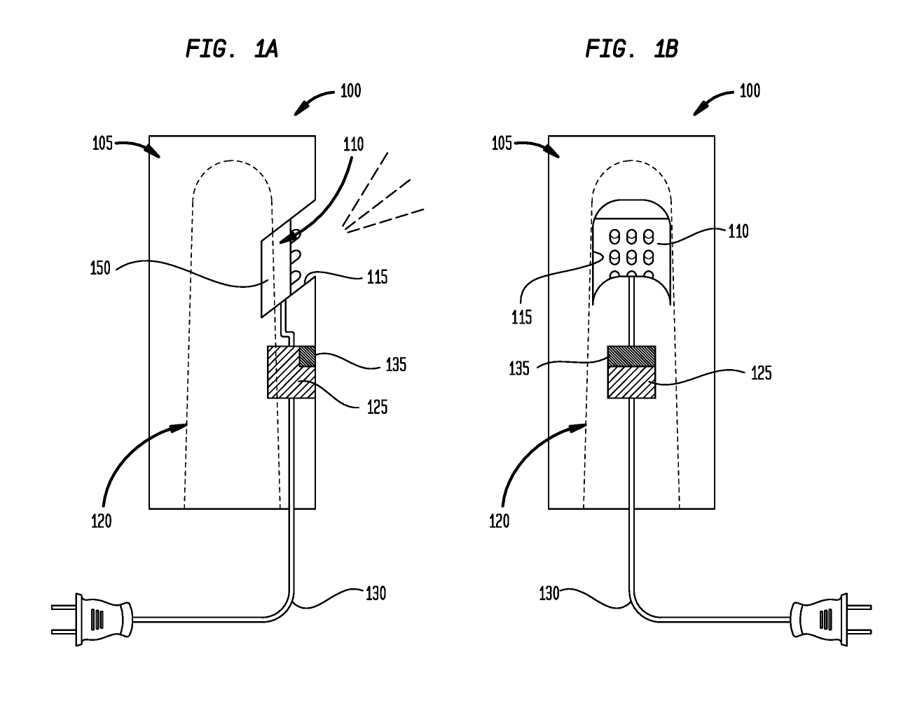

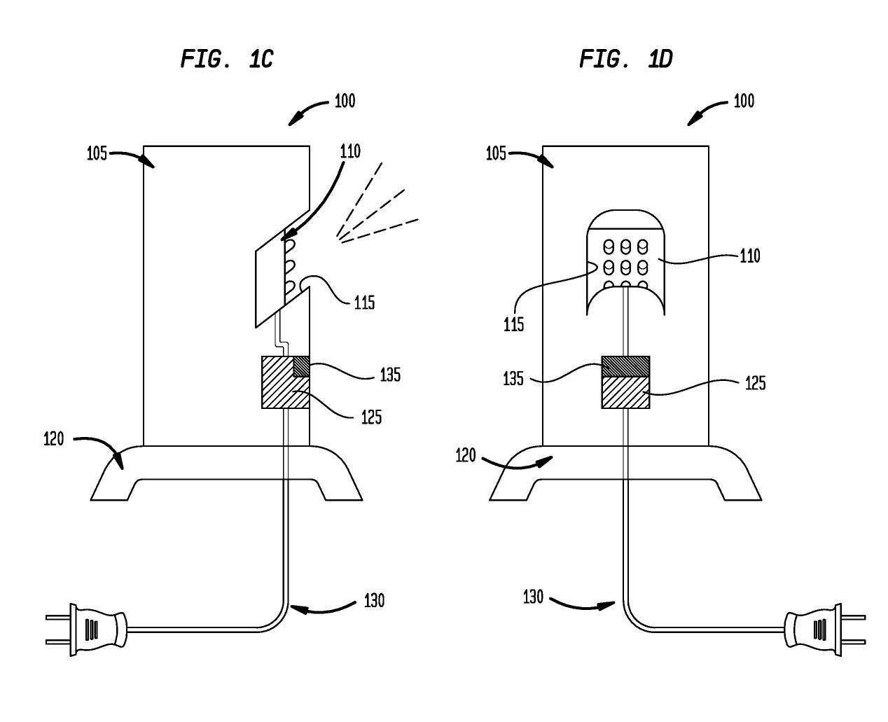

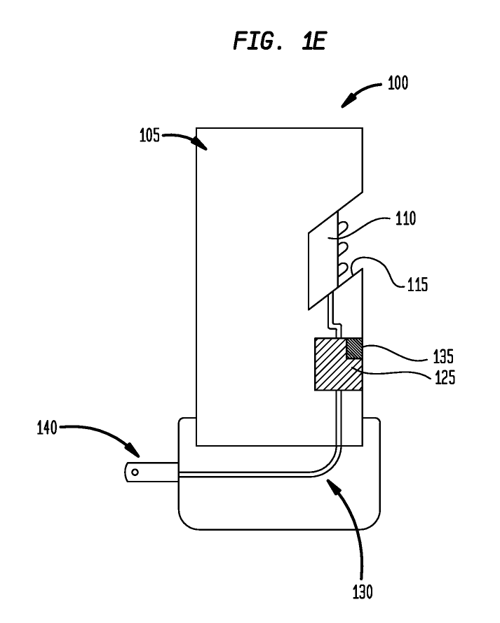

Referring now to FIGS. 1a and 1b, there is seen side and rear views, respectively, of a light show device 100 in accordance with the present invention. Light show device 100 includes a non-stabilizing frame 105, a light projection unit 110 positioned within a frame recess 115 of non-stabilizing frame 105, a power supply 125 with AC power cord 130 for providing operating power to light projection unit 110 and a stabilizer 120 for stabilizing device 100 while in use. As more fully described below, light show device 100 is operable indoors or outdoors to project still or moving images/scenes that illuminate an area within the vicinity of light show device 100. Light show device 100 may be used, for example, in conjunction with various holiday and other celebrations, such as Christmas, Hanukah, New Years, birthdays, etc.

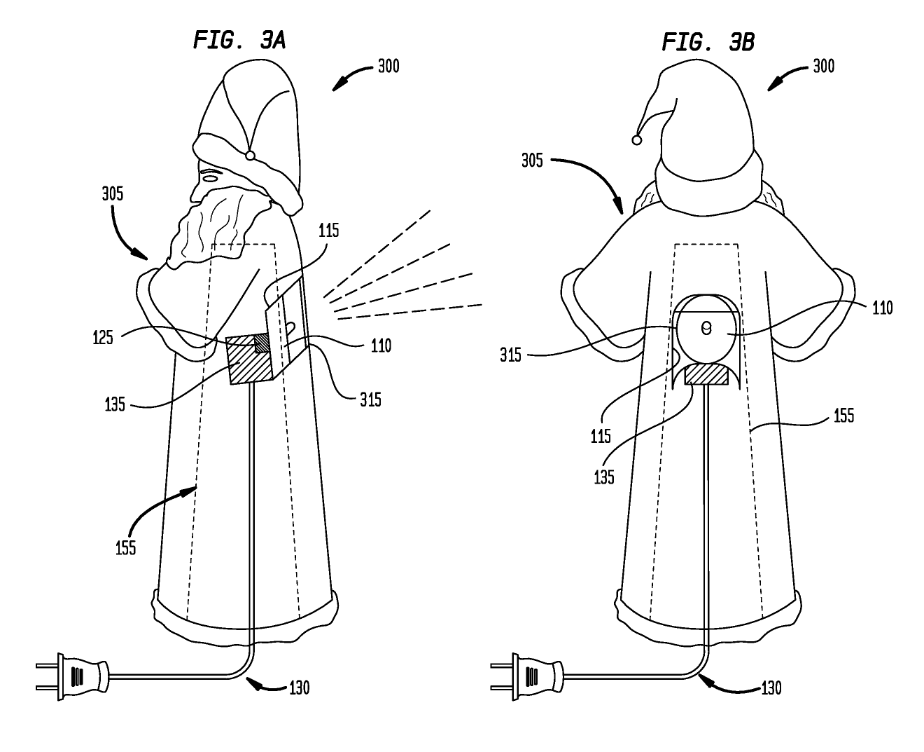

Light show device 100 includes a non-stabilizing frame 105 that is used in conjunction with a stabilizer 120 as discussed in greater detail below. However, alternate embodiments are envisioned in which the frame and the stabilizer are one piece (for example, see stabilizing frame 155 of FIG. 3). Non-stabilizing and stabilizing frame 105 and 155, respectively, may be of any suitable size and configuration structured to support light projection unit 110 for projection of still and/or moving images/scenes. For this purpose, non-stabilizing and stabilizing frame 105 and 155, respectively, may be constructed as a unitary piece or from multiple pieces, and may be manufactured (such as via casting or 3D printing) or handcrafted from any material(s) of sufficient strength to support light projection unit 110. For example, non-stabilizing and stabilizing frame 105 and 155, respectively, may be constructed from metal (e.g., titanium, precious metals), silicone, plastic, resin, polyresin, composites, rigid 3D printed materials, non-corrosive materials, stiff hypoallergenic materials, etc. The design and materials of non-stabilizing and stabilizing frame 105 and 155, respectively, may also be selected to ensure that light show device 100 is not excessively heavy or appears too clunky, for example, by constructing frame 105 from lightweight plastic.

Light projection unit 110 is positioned partially or entirely within frame recess 115 of non-stabilizing frame 105 and includes one or more light emitting element(s) operable to project still and/or moving images/scenes along one or more predefined directions with respect to light show device 100. In the embodiment depicted in FIGS. 1a and 1b, for example, frame recess 115 is formed within non-stabilizing frame 105 so as to orient light projection unit 110 for projection of the images/scenes in a rearward and upward direction with respect to non-stabilizing frame 105, for example, against a ceiling and/or upper portion of a wall or other structure. It should be appreciated, however, that frame recess 115 may be formed at other locations within non-stabilizing frame 105 for orienting light projection unit 110 to project the images/scenes along one or more other predefined directions or orientations with respect to non-stabilizing frame 105. For example, frame recess 115 may be formed within non-stabilizing frame 105 to orient light projection unit 110 for projection of the images/scenes from the front, left, right, top, bottom, etc. of frame 105. It should also be appreciated that light projection unit 110 need not be positioned within frame recess 115 of non-stabilizing frame 105, but rather may be attached to a suitable outer surface of non-stabilizing frame 105 for projection of the images/scenes along any desired direction. Of course, one of ordinary skill in the art will appreciate that light projection unit 110 may be affixed to non-stabilizing frame 105 (or a stabilizing frame) in various other manners, and that the present invention as a whole is not intended to be limited by or to any particular manner of affixing and/or orienting light projection unit 110 with respect to non-stabilizing frame 105.

Power supply 125 (which may be separate from or part of light projection unit 110) includes components and other circuitry, such as a transformer and/or other components, operable to convert base power received from a power source into operating power for light projection unit 110. For example, in the embodiment depicted in FIGS. 1a and 1b, power supply 125 and AC power cord 130 are operable together to receive AC power from an AC receptacle for providing the operating power to light projection unit 110. Components of power supply 125 and AC power cord 130 may extend along an outside surface of frame 105 or, alternatively, be positioned within frame 105. In lieu of or in addition to receiving AC power, power supply 125 may also receive power from other sources, such as DC power from a battery receptacle 135 structured to receive one or more batteries (not shown), thereby eliminating the need for AC power cord 130. In another embodiment, power supply 125 is operable to receive DC power from a solar panel or other device configured to receive energy from a light source, such as the sun. Of course, one of ordinary skill in the art will appreciate that light show device 100 may be powered in any suitable manner, and that the present invention as a whole is not intended to be limited by or to any particular manner of powering light show device 100.

Stabilizer 120 is structured to stabilize light show device 100 to ensure that device 100 remains sturdy and upright while in use. In the depicted embodiment, stabilizer 120 is a separate structure removably or permanently attached to frame 105. In the embodiment shown in FIGS. 1a and 1b, stabilizer 120 is shaped as a cone 120 for permitting light show device 100 to sturdily engage the top of a suitably shaped structure, such as a Christmas tree or other tree. In this embodiment, frame recess 115 of frame 105 is located adjacent stabilizer recess 150 such that a light projection unit 110 inserted into frame recess 115 may further extend into stabilizer recess 150 as needed. This may be required, for example, to accommodate a light projection unit 110 having a larger size than frame recess 115 and/or to provide additional support for light projection unit 110. In such an embodiment, at least a portion of AC power cord 130 extends through cone 120, although this is not required. Although the embodiment of the invention depicted in FIGS. 1A and 1B depict a separate frame and stabilizer, alternate embodiments are envisioned (such as that shown in FIGS. 3A and 3B) in which stabilization for the light show device is integral to the frame (e.g., see stabilizing frame 155 in FIGS. 3A and 3B).

In another embodiment, such as the one depicted in FIGS. 1c and 1d, stabilizer 120 forms a stand, pedestal or other structure for permitting light show device 100 to be positioned on a table or other substantially horizontal surface. In still another embodiment, stabilizer 120 forms a mount for rigidly coupling light show device 100 to a wall, ceiling, or other surface. In yet another embodiment, such as the one depicted in FIG. 1e, stabilizer 120 is in the form of a substantially horizontal stabilizer and it is combined with AC power cord 130, or a portion thereof (for example, the cord may be omitted) to form a coupling 140 compatible with a standard electric AC receptacle. Upon plugging the coupling 140 of light show device 100 into the receptacle, light show device 100 receives both stabilization and power from the AC receptacle (not shown), thereby permitting light show device 100 to be operated as, for example, a night light. It will be appreciated, however, that stabilizer 120 may form or include any structure configured to stabilize light show device 100 while in operation and that the present invention as a whole is not intended to be limited by or to any specific structure.

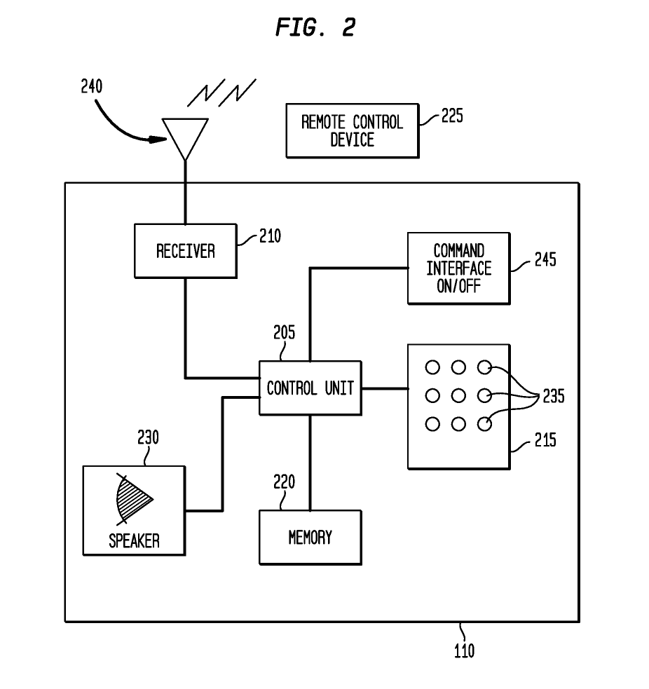

Referring now to FIG. 2, there is seen a schematic depiction of a light projection unit 110 in accordance with the present invention. Light projection unit 110 includes components and circuitry for generating and controlling the projection of the still and/or moving images/scenes. For instance, as shown in FIG. 2, light projection unit 110 may include: control unit 205, which may be a computing device such as a processor or other control circuitry designed to operate the projected lights; optionally, an antenna 240 and receiver 210 coupled to control unit 205 for receiving control signals or other data from a remote control device 225; one or an array 215 of light emitting element(s) 235 coupled to control unit 205; command interface 245 for receiving input from a user; and optionally a memory 220. Light projection unit 110 may also include a speaker 230 for playing various sound effects or music while the still or moving imagery is being projected, although it should be appreciated that various other embodiments need not include antenna 240, receiver 210, memory 220, or speaker 230 and/or the ability to receive commands from a remote control device, such as remote control device 225, or the ability to play sounds and music.

Light emitting element(s) 235 of array 215 may include, for example, one or more laser or light projection bulbs or light-emitting/laser diodes, solid state diode-pumped light sources, gas lasers and/or galvanometric scanners. In one embodiment, light emitting element(s) 235 (or mirrors associated with light emitting element(s) 235) may also be controllably moveable into various orientations so as to enable or assist in the projection of moving images or scenery. Alternatively, light emitting element(s) 235 may be rigidly mounted, such as, for example, with respect to a light projection unit 110 designed to project only still images or scenery. It should be appreciated, however, that the present invention as a whole is not intended to be limited by or to any particular type or model of light emitting element(s) 235.

Control unit 205 is operable to control all functions of light projection unit 110, such as various visual elements of the still and/or moving images/scenes projected from light projection unit 110. For this purpose, control unit 205 may constitute or include a general purpose processor, state machine, digital signal processor, other off-the-shelf components, or a combination of these, executing appropriate software or, alternatively, may include special purpose hardware and/or software. Such special purpose hardware may be designed and wired to perform its intended functions without the use of software. Any software executable by control unit 205 may be stored therein as firmware or, alternatively, may be stored in memory 220 (which may be volatile or non-volatile). Control unit 205 may be programmed to control one or more light emitting element(s) 235 to project one or more pre-loaded still or moving images/scenes of, for example, a snow storm, snow flakes, candy canes, snowmen, and/or other scenery. For example, in one embodiment, control unit 205 is programmed to control light emitting element(s) 235 to project snowflake-like images in a downwardly falling pattern, thereby simulating snowfall, e.g., around a Christmas tree or on a wall or other structure. In an alternative embodiment, control unit 205 may also be programmed to project one or more still or moving images/scenes created and uploaded to memory 220 by a user (e.g., a family photo or video, selected imagery or scenery, etc.), for example, wirelessly via receiver 210 or via a wired port, such as a USB port or other means (not shown). In this manner, the imagery projected from device 100 may be customized to the user's liking and tastes, and may be changed at will. Control unit 205 may also be programmed to play sounds or music via speaker 230. Such sounds or music may be stored, for example, in memory 220, retrieved by control unit 205 and played while the still or moving images/scenes are projected via light projection unit 110.

In the embodiment of FIG. 2, control unit 205 is also configured to receive commands from a remote control device 225 via receiver 210. Commands may include, for example, an ON command for turning on the projection of still and/or moving images/scenes, and OFF command for turning off the projection of still and/or moving images/scenes, and/or a NEXT or CHANGE command for switching to different still and/or moving images/scenes. In the event remote control device 225 communicates commands via Infrared (“IR”) signals, receiver 210 may include an IR receiver and other circuitry operable to decode and communicate the IR signals to control unit 205. Receiver 210 may alternatively be provided with circuitry operable to receive and decode radio-frequency (“RF”) signals from antenna 240 (as shown in FIG. 2) or signals communicated over another medium, such as one or more wires. In addition to or in lieu of remote control device 225, light projection unit 110 may be provided with a command interface 245 for receiving various commands (such as from a touch screen or array of buttons) for controlling light projection unit 110. In this manner, light projection unit 110 may be controlled without the need for remote control device 225. In its simplest form, command interface 245 is an on/off button wherein in the off mode, power is de-energized and in an on mode, light show device 110 is provided with power to allow it to operate in a predetermined manner.

Referring now to FIGS. 3a and 3b, there is seen side and rear views, respectively, of a light show device 300 in accordance with the present invention. Light show device 300 includes stabilizing frame 155, light projection unit 110 positioned within a frame recess 115 of frame 155, and skirting 305. In the depicted embodiment, battery receptacle 135, power supply 125 and AC power cord 130 are integral to light projection unit 110 (i.e., they are one sub-component of light show device 300). However, one of skill in the art will appreciate that both battery receptacle 135 and AC power cord 130 are not both required and either one may be eliminated without departing from the scope hereof.

In the embodiment shown in FIGS. 3a and 3b, skirting 305 is designed and shaped to form a Santa Claus, however, other symbols, animals, or characters, such as a star, a snowman, a scarecrow, a teddy bear, a king, a saint, or other symbol, animal, or character could be substituted without departing from the scope hereof. Skirting 305 is provided with an aperture 315, through which light projection unit 110 or its projection of still and/or moving images/scenes extends. Skirting 305 may also function to hide aesthetically unpleasing features of light show device 300, such as power supply 125 and AC power cord 130, or other features/structures of light show device 300 not intended to be seen. For example, with respect to the embodiment depicted in FIGS. 3a and 3b, power supply 125 and AC power cord 130 are positioned underneath skirting 305.

While the present invention has been illustrated by description of various embodiments and while those embodiments have been described in considerable detail, it is not the intention of applicant to restrict or in any way limit the scope of the invention to such details. Additional advantages and modifications will readily appear to those skilled in the art. The invention in its broader aspects is therefore not limited to the specific details and illustrative examples shown and described. Accordingly, departures may be made from such details without departing from the spirit or scope of the invention.

I claim:

1. A light show device, comprising:
a frame having a recess;
a decorative skirting positioned over the frame, the decorative skirting including at least one aperture;
a light projection unit positioned within the recess of the frame, the light projection unit being operable to project an image or scene along a predetermined direction with respect to the frame through the at least one aperture; and
a power supply for providing operating power to the light projection unit.

2. The light show device of claim 1, further comprising:
a stabilizer structured to stabilize the frame.

3. The light show device of claim 1, wherein the decorative skirting resembles a symbol, animal or character.

4. The light show device of claim 1, wherein the predetermined direction includes a direction facing rearward and upward with respect to the frame.

5. The light show device of claim 1, wherein the frame or the stabilizer includes a cone structured to engage with a top of a Christmas or other tree.

6. The light show device of claim 1, wherein the stabilizer includes at least one of a stand, a pedestal and other structure for permitting the frame to be positioned on a substantially horizontal surface.

7. The light show device of claim 1, wherein the stabilizer includes a mount for mounting the frame to a wall, a ceiling, or an electrical receptacle.

8. The light show device of claim 1, further comprising at least one of the group consisting of: an AC power cord for providing AC power to the power supply; a battery receptacle structured to receive at least one battery for providing DC power to the power supply, a solar panel for providing DC power to the power supply, and combinations thereof.

9. The light show device of claim 2, further comprising:
an AC power cord for providing AC power to the power supply;
wherein the stabilizer and the AC power cord together form a coupling that receives both stabilization and the AC power from an AC receptacle.

10. The light show device of claim 1, wherein the light projection unit includes a control unit and at least one light emitting element electrically coupled to the control unit, wherein the control unit is operable to control the at least one light emitting element to project the image or scene.

11. The light show device of claim 10, wherein the at least one light emitting element is selected from the group consisting of a laser, a light projection bulb, a light-emitting/laser diode, a solid state diode-pumped light source, a gas laser, a galvanometric scanner, and combinations thereof.

12. The light show device of claim 11, wherein the light emitting elements are moveable and controllable by the control unit to project the image or scene, the image or scene including a moving image or scene.

13. The light show device of claim 10, wherein the light projection unit includes a speaker electrically coupled to the control unit, the control unit operable to control playing of sounds or music from the speaker.

14. The light show device of claim 10, wherein the light projection unit includes a receiver for receiving data or commands from a remote control device.

15. The light show device of claim 1, wherein the decorative skirting includes at least one flap forming an opening through which at least one component of the device may be accessed.

16. A light show device, comprising:
a stabilizing frame having a front, a rear and a recess, the recess recessed in the rear of the frame and extending outwardly and upwardly towards the rear, the stabilizing frame in the shape of a cone and structured to engage with a top of a tree for stabilizing the light show device atop the tree;
a decorative skirting positioned over the frame and having an aperture;
a light projection unit positioned within the recess of the frame, the light projection unit being operable to project an image or scene rearward and upward with respect to the frame, the image or scene being projected through the aperture of the skirting; and
a power supply for providing operating power to the light projection unit.

17. A method of simulating snowfall inside a home, comprising the steps of:
placing a light show device atop a tree or on a horizontal surface or in an electrical receptacle, the light show device including:
a frame having a recess;
a decorative skirting positioned over the frame, the decorative skirting including at least one aperture;
a light projection unit positioned within the recess of the frame, the light projection unit being operable to project snowflake-like images in a rearward and upward direction with respect to the frame through the at least one aperture, the snowflake-like images projected in a downwardly falling pattern along a predetermined direction; and
a power supply for providing operating power to the light projection unit; and
energizing the light show device.
